(19) United States
(12) Patent Application Publication
(10) Pub. No.: US 2026/0093520 A1
(43) Pub. Date: Apr. 2, 2026

(54) ARTIFICIAL INTELLIGENCE BASED TASK EXECUTION ON AN ELECTRONIC DEVICE

(71) Applicant: Motorola Mobility LLC, Chicago, IL (US)

(72) Inventors: Amit Kumar Agrawal, Bangalore (IN); Rohit Sisodia, Naperville, IL (US); Dan Dery, Chicago, IL (US)

(73) Assignee: Motorola Mobility LLC, Chicago, IL (US)

(21) Appl. No.: 18/979,019

(22) Filed: Dec. 12, 2024

(30) Foreign Application Priority Data
Sep. 28, 2024 (IN) 202411073451

(51) Int. Cl. G06F 9/48; G06F 3/0482

(52) U.S. Cl. CPC G06F 9/4843; G06F 3/0482

(57) ABSTRACT

An electronic device receives a user input identifying a task requested by a user. One or more actions to be performed to carry out the task are identified based at least in part on an artificial intelligence model trained at least in part on information included in a personal knowledge base associated with the user, where at least one of the one or more actions is not specified by the user input. The electronic device then performs the one or more actions.

### BACKGROUND

As technology has advanced our uses for electronic devices have expanded. One such use is portable electronic devices, such as smartphones, which have become commonplace in our daily lives. For example, these devices are used to play music for us, provide navigational assistance to us, order products and services for us, and so forth. User inputs have traditionally been provided to these devices via a keyboard or a touchscreen. However, as technology has advanced, these devices have begun to support user voice inputs.

### BRIEF DESCRIPTION OF THE DRAWINGS

Embodiments of the techniques discussed herein are described with reference to the following drawings. The same numbers are used throughout the drawings to reference like features and components:

FIG. 1 illustrates an example environment in which aspects of the present disclosure can be implemented.

FIG. 2 illustrates another example environment in which aspects of the present disclosure can be implemented.

FIG. 3 illustrates an example task execution system in accordance with aspects of the present disclosure.

FIGS. 4-17 illustrate an example of performing a task in accordance with the techniques discussed herein.

FIGS. 18A and 18B illustrates a flow chart depicting an example method in accordance with one or more implementations.

FIGS. 19 and 20 illustrate examples of multiple applications in a split screen in accordance with the techniques discussed herein.

FIG. 21 illustrates a flow chart depicting an example method in accordance with one or more implementations.

FIG. 22 illustrates an example process for implementing the techniques discussed herein in accordance with one or more embodiments.

FIG. 23 illustrates an example process for implementing the techniques discussed herein in accordance with one or more embodiments.

FIG. 24 illustrates various components of an example electronic device that can implement embodiments of the techniques discussed herein.

### DETAILED DESCRIPTION

Artificial intelligence based task execution on an electronic device is discussed herein. Generally, a user inputs (e.g., text or voice) a request to the electronic device to perform a task. A task refers to a piece or amount of work to be done, such as ordering a drink or food, scheduling a car for pickup (e.g., using a ride sharing or ride-hailing application or service), ordering tickets for a musical or sporting event, and so forth. In response to the user input the task is automatically performed irrespective of third party or system applications on a given device. Limited input information regarding the task is provided by the user—e.g., one or more actions taken to perform the task are not specified by the user in the request to perform the task.

In one or more implementations, the electronic device uses a task execution system that includes at least one large language model (LLM) or large action model (LAM). The task execution system is trained, e.g., based on previous inputs from the user, what actions to take to perform the requested task. For example, if the user request is for the electronic device to order a coffee drink, the task execution system automatically performs actions to order the coffee drink that the user prefers (e.g., has previously ordered), such as clicking on an application icon (e.g., on a Home screen or Launcher user interface (UI)) corresponding to the desired store or brand of coffee to order, then clicking on an Order button, then clicking on a Location button, then scrolling down to the user's desired location, and so forth.

The task execution system learns the UI screens displayed for various requested tasks, as well as the UI elements to interact with to perform the requested tasks. The task execution system need not be aware of any application programming interfaces (APIs) exposed by any of the applications and need not access any APIs exposed by any of the applications or services in order to perform the requested tasks.

In one or more implementations the task execution system launches two or more applications to perform a task, and for each of the two or more applications determines and performs the actions for the task. At least one of the two or more applications to use to complete the task is determined based at least in part on which of the two or more applications are able to fulfill the task. This allows the electronic device to quickly pursue multiple options for performing the task (multiple different applications), and automatically select, or prompt the user to select, one of the applications to complete the task based on the ability of the two or more applications to fulfill the task.

Various aspects of implementations described herein can leverage artificial intelligence (AI) functionality (e.g., AI and/or machine learning algorithms, AI and/or machine learning models, etc.) to determine actions to take to perform a task. As discussed herein, the terms “AI” and “machine learning” can be used to refer to machine-implemented intelligence for performing various tasks on data, such as data analysis, data classification, data modification, data generation, etc. For instance, AI functionality can be used for identifying a task being requested by a user, one or more AI generative models for generating a list of steps to perform a task, one or more AI generative models for identifying actionable UI elements displayed by an electronic device, and so forth. The described implementations can utilize different types of AI models, such as classifier models, generative models, prediction models, combinations thereof, etc.

While features and concepts of the techniques discussed herein can be implemented in any number of environments and/or configurations, aspects of these techniques are described in the context of the following example systems, devices, and methods. Further, the systems, devices, and methods described herein are interchangeable in various ways to provide for a wide variety of implementations and operational scenarios.

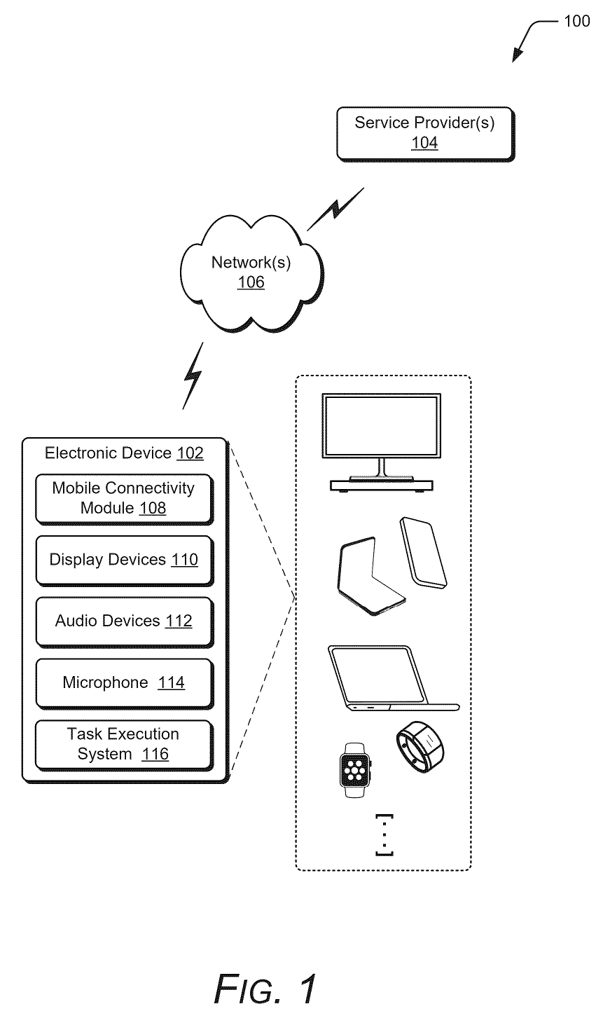

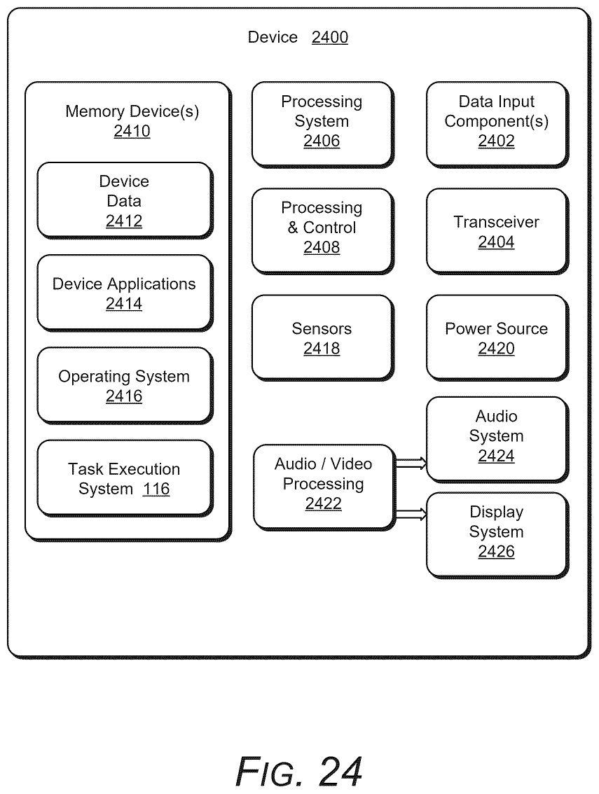

FIG. 1 illustrates an example environment 100 in which aspects of the present disclosure can be implemented. The environment 100 includes an electronic device 102, and one or more service providers 104 that are interconnectable via one or more networks 106. The electronic device 102 can be implemented in various ways, such as a mobile device (e.g., a smartphone), a mobile foldable device (e.g., a foldable smartphone, a foldable tablet device), a laptop computing device, a desktop computing device, a wearable device (e.g., a smartwatch, an augmented reality headset or device, a virtual reality headset or device), an entertainment device (e.g., a gaming console, a portable gaming device, a streaming media player, a digital video recorder, a music or other audio playback device), a video camera, an Internet of Things (IoT) device, an automotive computer, and so forth. Example attributes of the electronic device 102 are discussed below with reference to the device 2400 of FIG. 24.

The electronic device 102 includes various functionality that enables the electronic device 102 to perform different aspects of the techniques discussed herein, including a mobile connectivity module 108, display devices 110, audio devices 112, a microphone 114, and a task execution system 116. The mobile connectivity module 108 represents functionality (e.g., logic and hardware) for enabling the electronic device 102 to interconnect with other devices and/or networks, such as the network 106. The mobile connectivity module 108, for instance, enables wireless and/or wired connectivity of the electronic device 102.

The display devices 110 represent functionality for outputting visual content via the electronic device 102. The electronic device 102 includes one or more display devices 110 that can be leveraged for outputting content. The audio devices 112 represent functionality for providing audio output for the electronic device 102. In at least one implementation the electronic device 102 includes audio devices 112 positioned at different regions of the electronic device 102, such as to provide for different audio output scenarios. The microphone 114 represents functionality for receiving audible inputs from a user of the electronic device 102. The microphone 114 can be configured, for example, as any suitable type of microphone incorporating a transducer that converts sound into an electrical signal.

The task execution system 116 represents functionality to identify a task to be performed for the user of the electronic device 102 and select an application to perform the task. This identification and selection can be based at least in part on, for example, a speech or text user input to the electronic device 102, AI functionality, and a personal knowledge base including various information about the user. In one or more implementations, selection of the task is based on fulfillment capability of at least one service provider 104 as discussed in more detail below. The electronic device 102 can interact with a service provider 104 via, for example, an application installed on the electronic device 102 or a web site exposed by the service provider 104.

The task execution system 116 can be implemented in a variety of different manners. For example, the task execution system 116 can be implemented as multiple instructions stored on computer-readable storage media and that can be executed by a processing system (e.g., one or more processors). Additionally or alternatively, the task execution system 116 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth). Furthermore, the task execution system 116 can be implemented at least in part as part of an operating system of the electronic device 102.

As described above, different operations of the task execution system 116 can be performed using AI functionality, such as one or more AI classifier models for identifying a task being requested by a user, one or more AI generative models for generating a list of steps to perform a task, one or more AI generative models for identifying actionable user interface (UI) elements displayed by an electronic device, and so forth.

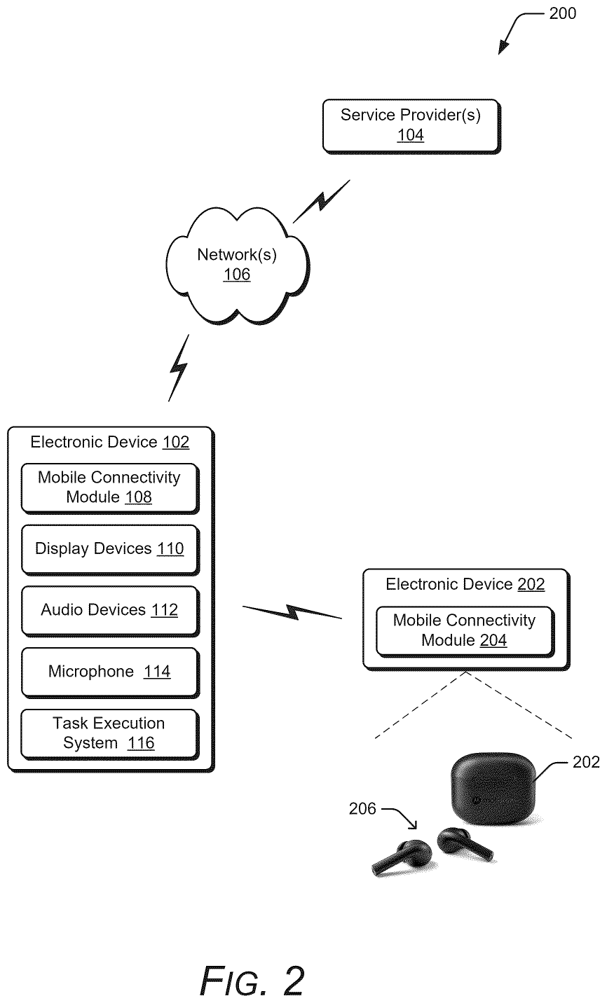

FIG. 2 illustrates another example environment 200 in which aspects of the present disclosure can be implemented. The environment 200 includes the electronic device 102, the one or more service providers 104, and the one or more networks 106, analogous to the discussion in FIG. 1. The environment 200 also includes an electronic device 202 that includes a mobile connectivity module 204. The mobile connectivity module 204 represents functionality (e.g., logic and hardware) for enabling the electronic device 202 to interconnect with other devices and/or networks, such as the electronic device 102 and the network 106. The mobile connectivity module 204, for instance, enables wireless and/or wired connectivity of the electronic device 202. The electronic device 202 can include many of the same types of components as are included in the electronic device 102, and example attributes of the electronic device 202 are discussed below with reference to the device 2400 of FIG. 24.

In one or more implementations, the electronic device 202 is a case (e.g., a housing) that stores a pair of ear buds 206. The ear buds 206 include a microphone and speakers, so when a user is wearing the ear buds 206 (e.g., the ear buds 206 are inserted into the user's ears), the user can input audible commands via the microphone that are transmitted to the electronic device 102. Similarly, responses to the audible commands can be transmitted from the electronic device 102 to the ear buds 206 for playback via the speakers. Communication between the ear buds 206 and the electronic device 102 can be direct or performed via the electronic device 202. For example, a Bluetooth connection can be established between the electronic device 102 and the ear buds 206, allowing direct communication between the electronic device 102 and the ear buds 206 that need not pass through the electronic device 202.

By way of another example, a Bluetooth connection can be established between the electronic device 202 and the ear buds 206, and a modem of the electronic device 202 may be used to establish a connection between the electronic device 202 and the electronic device 102 (e.g., over various radio access technologies including third generation (3G) radio access technology, fourth generation (4G) radio access technology, fifth generation (5G) radio access technology, among other suitable radio access technologies beyond 5G (e.g., sixth generation (6G))). Accordingly, communication between the electronic device 102 and the ear buds 206 passing through the electronic device 202 can be established. Thus, it should be noted that the electronic device 202 need not be in close physical proximity (e.g., within Bluetooth range) of the electronic device 102.

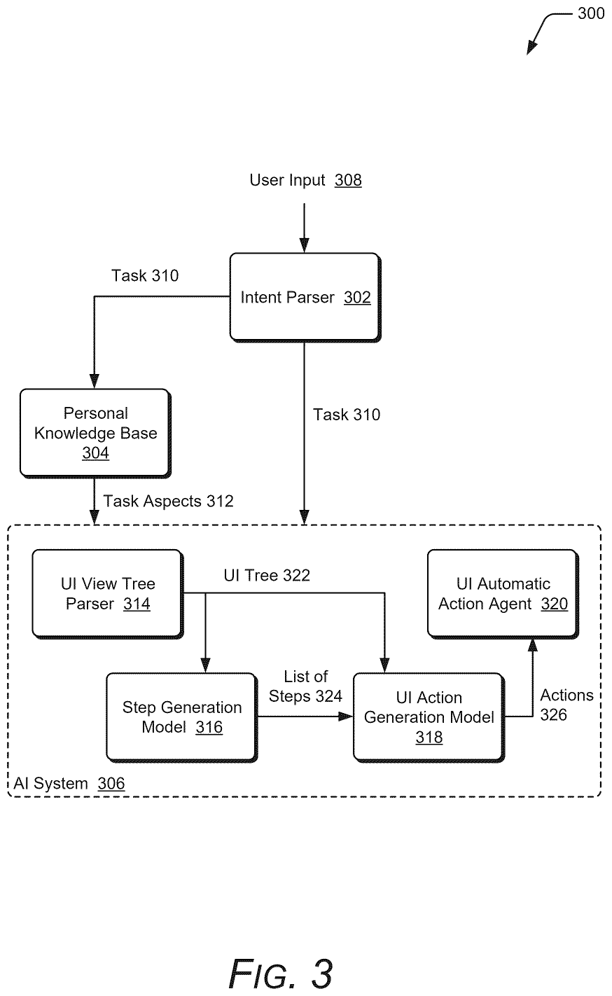

FIG. 3 illustrates an example task execution system 300 in accordance with aspects of the present disclosure. The task execution system 300 is, for example, a task execution system 116 of FIG. 1 or FIG. 2. The task execution system 300 includes an intent parser 302, a personal knowledge base 304, and an AI system 306. The intent parser 302 receives a user input 308, such as a voice or text input. If not received in a text form, the user input 308 is converted into a text form. For example, an automatic speech recognizer can be used to convert a voice input to text. The user input 308 is an indication or prompt of what task the user is requesting the task execution system 300 to perform. For example, the user input 308 may be “order my coffee” or “play classical music.” The intent parser 302 identifies what task the user is requesting. In one or more implementations, the intent parser 302 is an AI classification model trained using various different user inputs to identify the task being requested. The AI model can be trained, for example, using supervised or unsupervised learning. The intent parser 302 provides an indication of the identified task 310 to the personal knowledge base 304 and the AI system 306.

The personal knowledge base 304 stores various information regarding the user and provides information relevant to the task 310 to the AI system 306. This information can be stored, for example, in response to user consent to store the information being received. The information stored by the personal knowledge base 304 can be any data or information regarding the user or the electronic device being used by the user. In one or more implementations, the stored information can be data input by the user, data obtained from other applications (e.g., calendaring applications, airline or travel applications, email applications), data identified by the electronic device (e.g., a physical or geographic location of the electronic device), actions taken with or by the electronic device at particular times of the day), or a combination thereof. The information stored by the personal knowledge base 304 can include location information, movement information, previously performed tasks, aspects of tasks previously performed, accepted, or requested by a user of the electronic device, and the like.

Examples of location information stored by the personal knowledge base 304 include global positioning system (GPS) coordinates, businesses or groups the electronic device is near (e.g., based on Bluetooth low energy (BLE) or near field communication (NFC) signals received by the electronic device), whether the electronic device is at work or home, whether the electronic device is at home or traveling in another city, state, or country, and the like. These locations can optionally be combined with a time (e.g., time of day, day of week or month). E.g., the stored information can include the location of the electronic device at a particular time of day every day of the week.

Examples of movement information stored by the personal knowledge base 304 include whether the electronic device is stationary or moving, a speed at which the electronic device is moving (e.g., in miles per hour), a type of transportation being used (e.g., walking, in a car, using public transportation), and the like.

With respect to previously performed tasks, a task refers to a piece or amount of work to be done. A previously performed task can be, for example, anything that the user has previously done using the electronic device, such as by interacting with an application running on the electronic device, interacting with a service offered by a service provider, and so forth. For example, a task can be ordering a drink or food, making travel plans or reservations (e.g., scheduling a car for pickup (e.g., using a ride sharing or ride-hailing application or service), making an airplane or train reservation), making a dinner reservation at a restaurant, ordering tickets for a musical or sporting event, paying a bill or paying for a service, scheduling an appointment, paying for parking, playing music, and so forth.

With respect to aspects of tasks previously performed, accepted, or requested by a user of the electronic device, aspects of a task refer to the actions taken or choices made to accomplish the task. Different tasks can have different aspects. For example, for the task of ordering a coffee drink, the aspects may include selecting an application or service provider to use to order the coffee drink, a location to pick up the coffee drink, the type of coffee drink (e.g., americano, drip, latte), selecting the size of the drink, selecting any additions to the drink (e.g., flavors), selecting a type of milk to use for the drink (e.g., skim milk, 2% milk, whole milk), selecting whether the drink is hot or cold.

The personal knowledge base 304 provides the aspects of the task 310 to the AI system 306 as task aspects 312. For example, all of the aspects of a coffee ordering task can be stored in the personal knowledge base 304 as associated with the coffee ordering task. Those aspects can include any of the information discussed above, such as the type of coffee drink, the size of the coffee drink, the application or service provider used to order the coffee drink, a time of day that the task was performed, and so forth. In one or more implementations, the aspects of different tasks can be stored separately in the personal knowledge base 304 (e.g., a list of aspects associated with the task). Additionally or alternatively, all aspects of all tasks are provided to the AI system 306 and can be used for further training of one or more models of the AI system 306.

The AI system 306 includes a UI view tree parser 314, a step generation model 316, a UI action generation model 318, and a UI automatic action agent 320. Generally, the UI view tree parser 314 generates a UI tree, which is a tree of actionable UI elements on an electronic device. The step generation model 316 generates a list of steps to be taken for the task 310. The UI action generation model 318 generates a list of actions to be taken, based on the UI tree and the list of steps, for the task 310. The UI automatic action agent 320 performs the actions to be taken for the task 310.

The UI view tree parser 314 generates a UI tree 322 identifying all of the actionable UI elements on the display of the electronic device at a time. An actionable UI element refers to a UI element that a user can interact with (e.g., a button the user can touch, an icon the user can touch, a field where an alphanumeric value can be input, a slider or scroll bar that can be selected and/or moved, a drop down menu from which a selection can be made, a radio button that can be selected). In one or more implementations, the UI view tree parser 314 is a LLM or LAM that can be trained, for example, using supervised or unsupervised learning. In one or more implementations, the UI view tree parser 314 is trained using the actions previously performed by the user in performing a task. The UI tree can be in an extensible markup language (XML) format. For example,
<xml><node 1><node2>
   indicating a current UI screen (a current layer of the UI tree) displays two actionable UI elements (node1 and node2).

As the user performs a task different UI screens are displayed in response to the user's input. All actions taken by the user on the display screen (all user inputs to the display screen) are recorded and saved to be used for future task execution. This creates a UI tree with each layer indicating the actionable UI elements displayed on the UI screen at that layer. This information can be saved in the personal knowledge base 304 or in a separate store or cache. This information can be stored in a vector/text format and used to augment prompts or queries to the step generation model 316 or UI action generation model 318 as well as reduce the need to save queries to the step generation model 316 or the UI action generation model 318. Different UI trees 322 can be generated for different tasks as well as for different applications performing the same task.

The step generation model 316 is an AI generative model trained to generate a list of steps 324 to perform the task 310 based at least in part on the task aspects 312. In one or more implementations, the step generation model 316 is an LLM or LAM that can be trained, for example, using supervised or unsupervised learning. The step generation model 316 can be trained using the actions previously performed by the user in performing a task as well as the UI tree 322. The task 310 and task aspects 312 are input to the trained step generation model 316, which generates the appropriate list of steps 324 to perform the task 310 for the user. The list of steps 324 is a list of the steps to take and the order in which to take them in order to perform the task 310. For example, for a coffee ordering task, the list of steps 324 can be to tap on an application icon corresponding to the desired store or brand of coffee to order, then tap on the order button, then select a store location, and so forth.

The UI action generation model 318 is an AI generative model trained to generate UI actions 326 to take to implement the list of steps 324. Each action 326 is, for example, a list of which one or more nodes in the UI tree 322 to act upon to perform a step. In one or more implementations, the UI action generation model 318 is an LLM or LAM that can be trained, for example, using supervised or unsupervised learning. The UI action generation model 318 can be trained using the actions previously performed by the user in performing a task as well as the UI tree 322 and the list of steps 324. The list of steps 324 and the UI tree 322 are input to the trained UI action generation model 318, which generates the appropriate actions 326 to perform the task 310 for the user. Each action 326 is indicated in terms of interacting with one or more UI elements (e.g., clicking this UI element, inputting text in this other UI element, scroll this view, and so forth). For example, for a coffee ordering task, the actions 326 can include click, in the Launcher UI, on the application icon corresponding to the desired store or brand of coffee to order, click on the Order button, click on the Location node, scroll down to the Merchandise Mart location, and so forth.

The UI action generation model 318 learns the answers to any prompts, or what action to perform, based at least in part on the list of steps 324 (which is based at least in part on the personal knowledge base 304). So, using the UI tree 322, when a particular UI screen is displayed, the task execution system 300 knows which action to take. For example, the UI action generation model 318 can learn what application or web service to use (e.g., what icon on a home screen to click on) when the user asks to order coffee, or learn which option to choose when the application or web service prompts the user to choose a type of milk for their coffee, or learn what type of coffee drink the user orders (e.g., caffeinated or decaffeinated) at different times of day. By way of another example, the UI action generation model 318 can learn what type of car or ride to request (e.g., from a ridesharing application or service) based on who the user is traveling with (e.g., family, co-workers, just spouse). Such learning can be based on various information from the personal knowledge base 304, such as location information of other users being tracked (e.g., information which indicates that the user and his spouse are in Seattle but their kids are at home in Los Angeles with their grandparents), traveling companions (e.g., the last time the user traveled out of the country with his grandparents he always ordered a particular size car), and the like.

The UI automatic action agent 320 performs the actions 326. For example, the UI automatic action agent 320, for the coffee ordering task, can provide an input to the UI of the electronic device to click on the application icon corresponding to the desired store or brand of coffee to order, then provide an input to the UI of the electronic device to click on the Order button, then provide an input to the UI of the electronic device to click on the Location node, then provide an input to the UI of the electronic device to scroll down to the Merchandise Mart location, and so forth.

Accordingly, it should be noted that the actions are taken based on the UI tree. The UI automatic action agent 320 need not be aware of any application programming interfaces (APIs) exposed by any of the applications or services and need not access any APIs exposed by any of the applications or services. Rather, the UI automatic action agent 320 uses the UI tree indicating functionality exposed by the applications or services.

In one or more implementations, the UI automatic action agent 320 prompts the user to accept or reject the actions performed by the UI automatic action agent 320. This prompt can be displayed, for example, prior to performing the last action in the list of actions 326, which is clicking on a prompt or button to accept, confirm, or place the order. Additionally or alternatively, the user manually performs the last action to be performed for the task, which is clicking on a prompt or button to accept, confirm, or place the order. In such situations, the UI automatic action agent 320 does not perform, or the list of actions 326 does not include, the last action to be performed for the task, which is clicking on a prompt or button to accept, confirm, or place the order.

After the task is completed, one or both of the step generation model 316 or the UI action generation model 318 can be re-trained using the list of steps 324 or a list of the actions 326, and an indication of whether the user accepted or rejected the order.

Although illustrated as two separate models, additionally or alternatively the step generation model 316 and the UI action generation model 318 are implemented as a single model. In such situations, the single model is an AI generative model trained to generate a list of UI actions 326 to perform the task 310 based at least in part on the task aspects 312. The list of actions 326 is, for example, a list of which one or more nodes in the UI tree 322 to act upon to complete the task 310.

In one or more implementations, the single model is an LLM or LAM that can be trained, for example, using supervised or unsupervised learning. The single model can be trained using the actions previously performed by the user in performing a task as well as the UI tree 322 generated by the UI view tree parser 314. The task 310 and task aspects 312 are input to the trained single model, which generates the appropriate list of actions 326 to perform the task 310 for the user. The list of actions 326 is a list of the actions to take in terms of actionable steps on one or more UI elements as discussed above.

In one or more implementations, the UI actions performed by the UI automatic action agent 320 are performed in the foreground. Performing the actions in the foreground refers to the results of each of the actions being displayed on the electronic device, so the user is able to watch the actions and the application or service responses to those actions as they occur. Additionally or alternatively, the UI actions performed by the UI automatic action agent 320 are performed in the background (e.g., in a background window that is not currently displayed or visible to the user). When performing the actions in the background the results of each the actions not being displayed on the electronic device, so the user is not able to watch the actions and the application or service responses to those actions as they occur. Rather, the user can interact with other applications or services using the electronic device while the task is performed in the background.

Additionally or alternatively, the UI actions performed by the UI automatic action agent 320 are performed virtually, e.g., on another device. For example, referring to FIG. 2, the user can request a task by inputting a verbal command to the ear buds 206, and the electronic device 102 performs the task. In such situations, the UI automatic action agent 320 can provide an audible feedback to the user via the ear buds 206 to confirm or accept the task, and the user responds via interaction with the ear buds 206 (e.g., voice input to the ear buds 206, a motion input to the ear buds 206 such as the user nodding his or her head up and down).

As an example of using the task execution system 300, a user may want to order his favorite coffee. The task execution system knows that the user buys coffee every work-day around 9 AM and therefore automatically orders the user's favorite coffee after confirming with the user (e.g., when the user leaves for work in the morning). The user does not need to be concerned with launching the application and spending time creating and placing his order.

As another example of using the task execution system 300, a user may be travelling to a city that she has never visited and she has a conference to attend starting at a specific time. The task execution system can book the ride based on the user's schedule, making the entire process much easier, specifically by reducing the work of launching an application, searching through options to book a ride, finding the drop-off address, and so forth.

As another example of using the task execution system 300, suppose that a user is chatting with his mother on a messaging application on his electronic device and she asks for pictures of his kid's birthday as she was unable to attend. The user can ask the task execution system to share pictures from his electronic device while he is still on the messaging application. The task execution system finds the album link and then shares it on the messaging application chat with his mom.

As another example of using the task execution system 300, suppose that a family of five people have flown to a foreign country and have ordered a rideshare using a rideshare application. Given the number of people travelling, the user has specified a larger vehicle is needed, preferably a model or class of vehicle that includes captain seats. When the user subsequently prompts the task execution system to order a rideshare while still in the same foreign country (or while away from his home country), the task execution system can order the rideshare for a vehicle of the desired model or class.

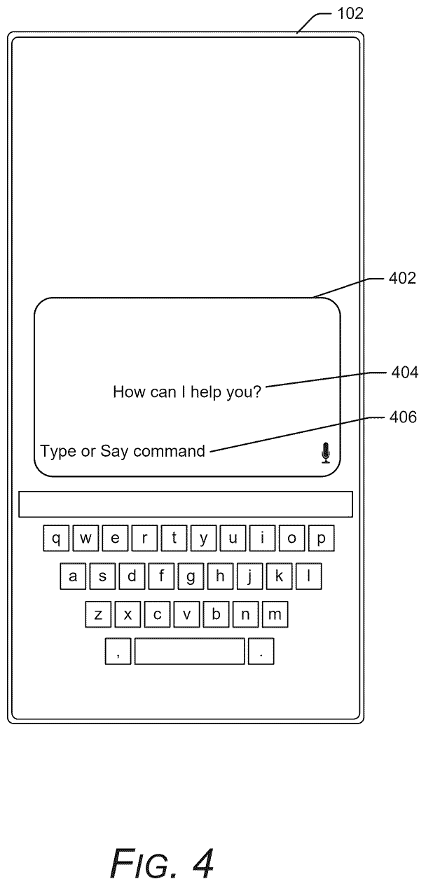

FIGS. 4-17 illustrate an example of performing a task in accordance with the techniques discussed herein. FIG. 4 illustrates an electronic device 102 displaying, in a window 402, a prompt 404 of “How can I help you? ” and a prompt 406 of “Type or Say command”. The window 402 is displayed, for example, by the task execution system 116.

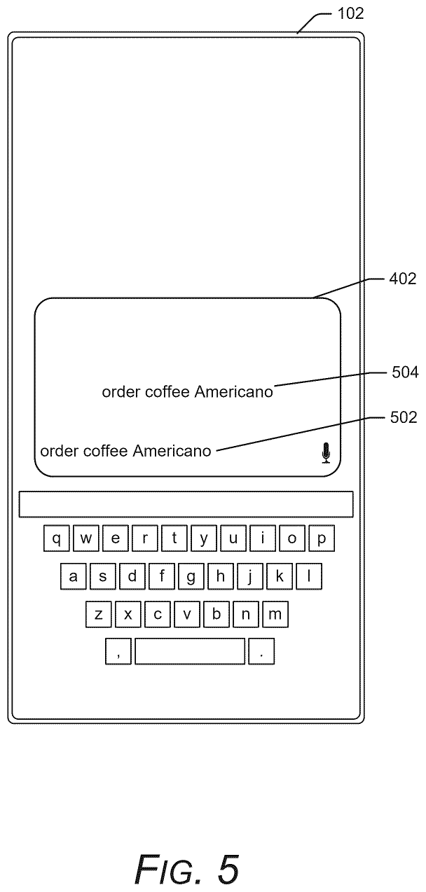

FIG. 5 illustrates the electronic device 102 after the user has input the prompt 502 of “order coffee Americano” and displaying back the prompt 504 that was received.

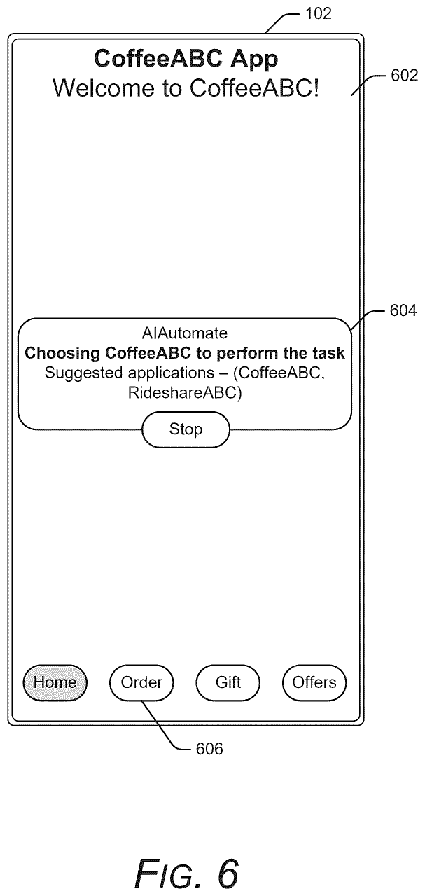

FIG. 6 illustrates the electronic device 102 after the task execution system 116 has taken the action of selecting an application corresponding to a coffee store named “CoffeeABC”. The application UI 602 is displayed, showing a home screen. A notification 604 is also displayed that CoffeeABC was chosen to perform the task. The notification 604 also indicates another suggested application (RideshareABC) to perform the task.

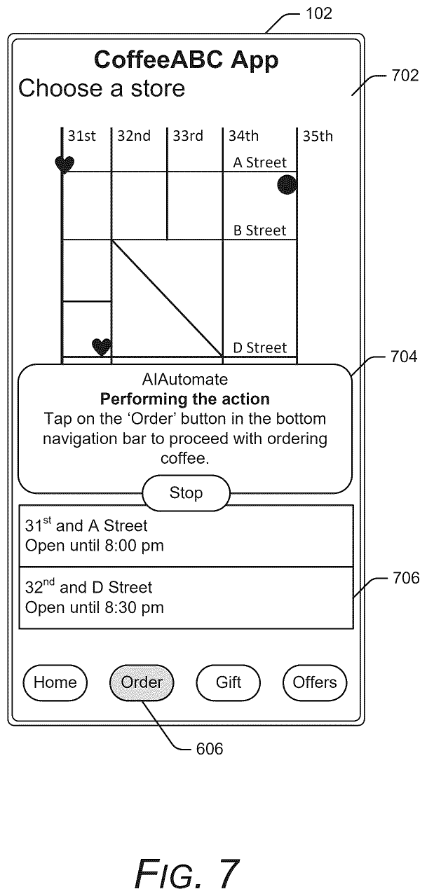

FIG. 7 illustrates the electronic device 102 after the task execution system 116 has taken the action of tapping on the Order button 606 illustrated in FIGS. 6 and 7. After tapping on the Order button 606, the application UI 702 is displayed including two store options for CoffeeABC. A notification 704 is also displayed indicating that the action of tapping on the Order button 606 was taken.

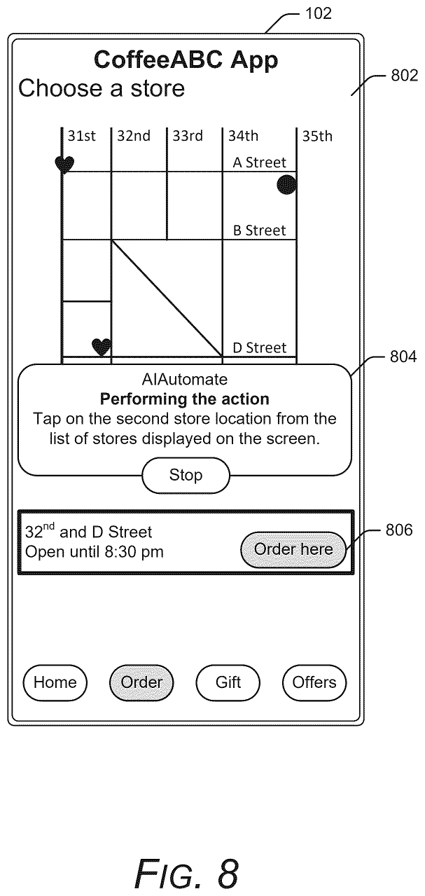

FIG. 8 illustrates the electronic device 102 after the task execution system 116 has taken the action of tapping on the second store location 706 illustrated in FIGS. 7 and 8. After tapping on the second store location 706, the application UI 802 is displayed including the second store location 706 as selected (e.g., highlighted). A notification 804 is also displayed indicating that the action of tapping on the second store location 706 was taken.

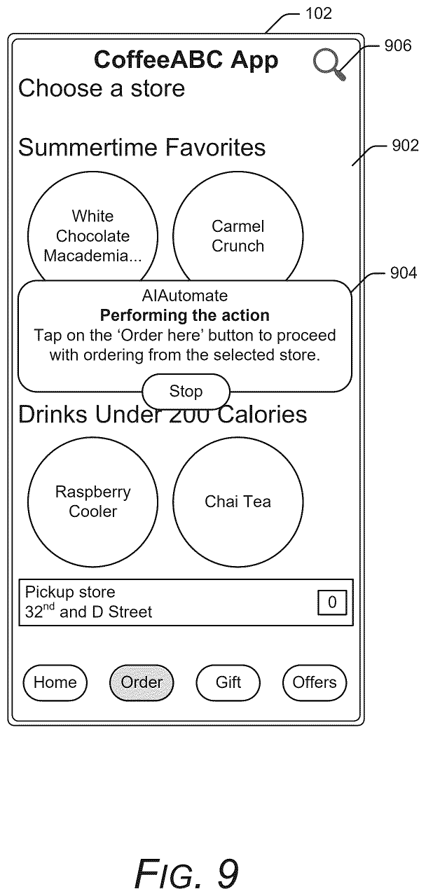

FIG. 9 illustrates the electronic device 102 after the task execution system 116 has taken the action of tapping on the “Order here” button 806 illustrated in FIG. 8. After tapping on the order here button 806, the application UI 902 is displayed, which is drink selection screen for CoffeeABC. A notification 904 is also displayed indicating that the action of tapping on the “Order here”button 806 was taken.

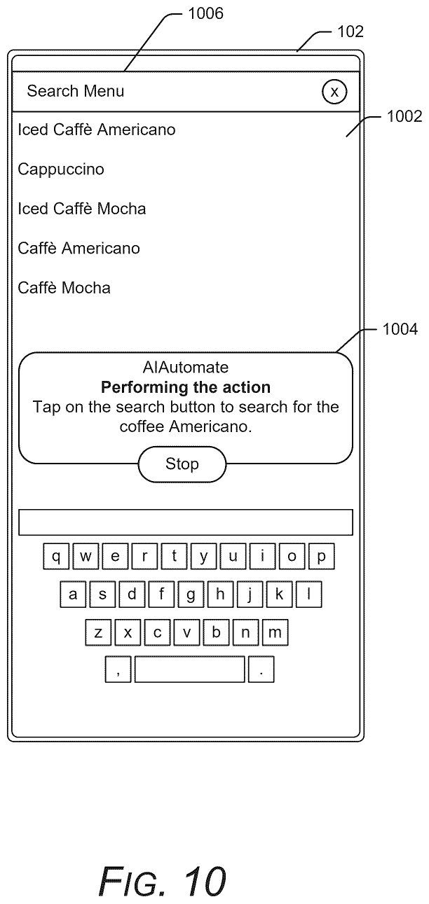

FIG. 10 illustrates the electronic device 102 after the task execution system 116 has taken the action of tapping on the Search button 906 illustrated in FIG. 9 to search for the coffee Americano. After tapping on the Search button 906, the application UI 1002 is displayed, which is a search screen for CoffeeABC. A notification 1004 is also displayed indicating that the action of tapping on the Search button 906 was taken.

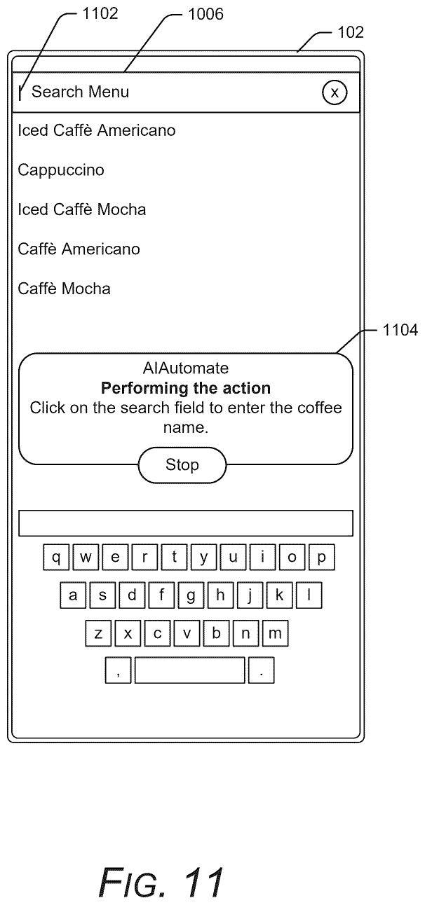

FIG. 11 illustrates the electronic device 102 after the task execution system 116 has taken the action of clicking on the search field 1006 illustrated in FIGS. 10 and 11 to enter the coffee name. After tapping on the search field 1006, a cursor 1102 is illustrated in the search field 1006. A notification 1104 is also displayed indicating that the action of clicking on the search field 1006 was taken.

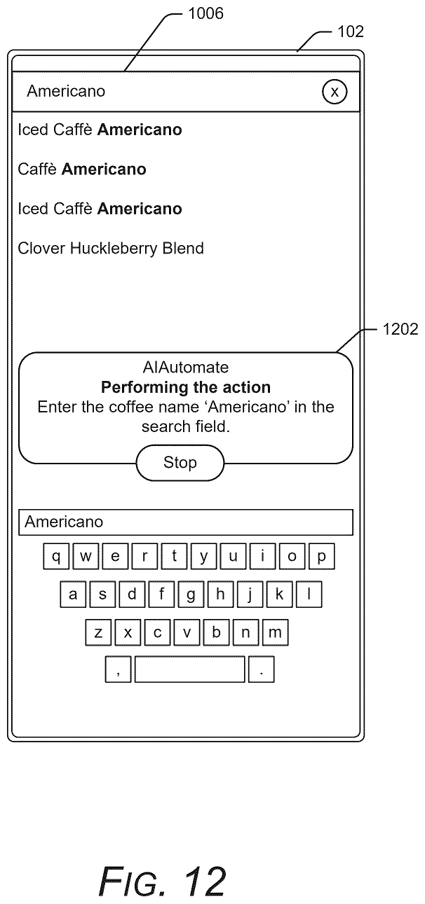

FIG. 12 illustrates the electronic device 102 after the task execution system 116 has taken the action of entering the coffee name “Americano” in the search field 1006. After entering the coffee name, the coffee name “Americano” is displayed in the search field 1006. A notification 1202 is also displayed indicating that the action of entering the coffee name “Americano”in the search field 1006 was taken.

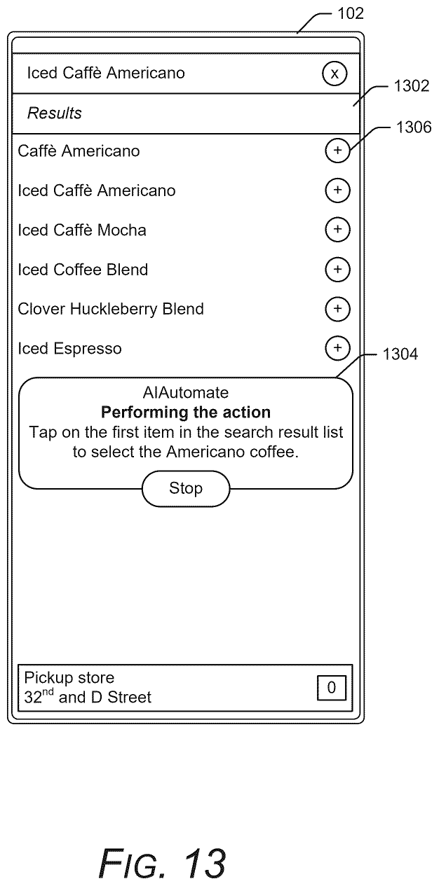

FIG. 13 illustrates the electronic device 102 after the task execution system 116 has taken the action of tapping on the first item in the search result list 1302. A notification 1304 is also displayed indicating that the action of tapping on the first item in the search result list 1302 was taken.

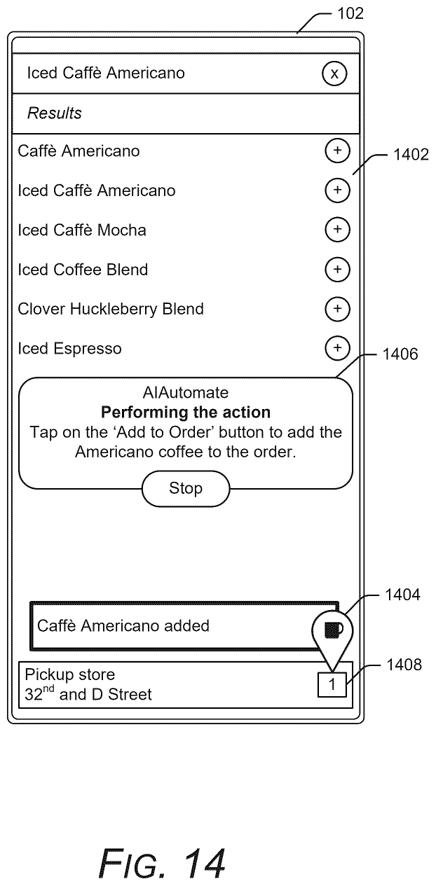

FIG. 14 illustrates the electronic device 102 after the task execution system 116 has taken the action of tapping the “Add to Order” button 1306 illustrated in FIG. 13. After tapping on the “Add to Order” button 1306, the application UI 1402 is displayed, indicating at 1404 that one CafféAmericano has been added to the order. A notification 1406 is also displayed indicating that the action of tapping the “Add to Order”button 1306 was taken.

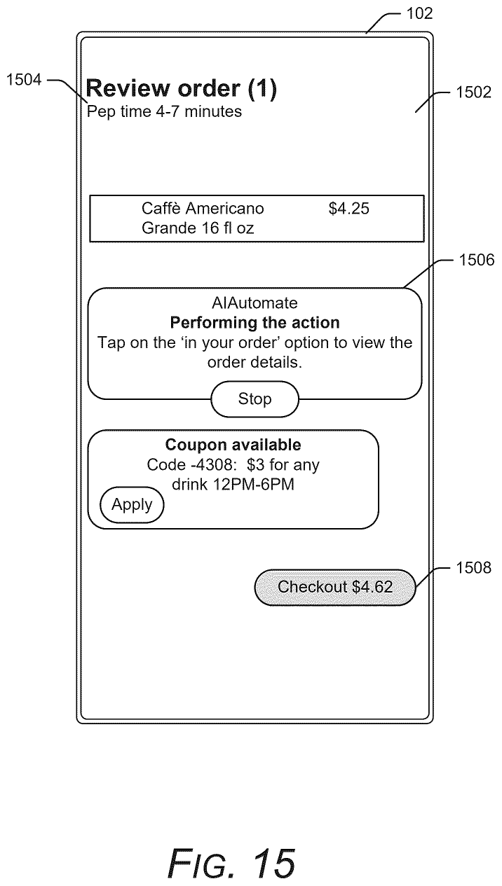

FIG. 15 illustrates the electronic device 102 after the task execution system 116 has taken the action of tapping the “in your order” option 1408 illustrated in FIG. 14. After tapping the “in your order” option 1408, the application UI 1502 is displayed, indicating the order is for one CafféAmericano. Additional information may also be displayed, such as an indication 1504 of the amount of time it will take to prepare the order. A notification 1506 is also displayed indicating that the action of tapping the “in your order”option 1408 was taken.

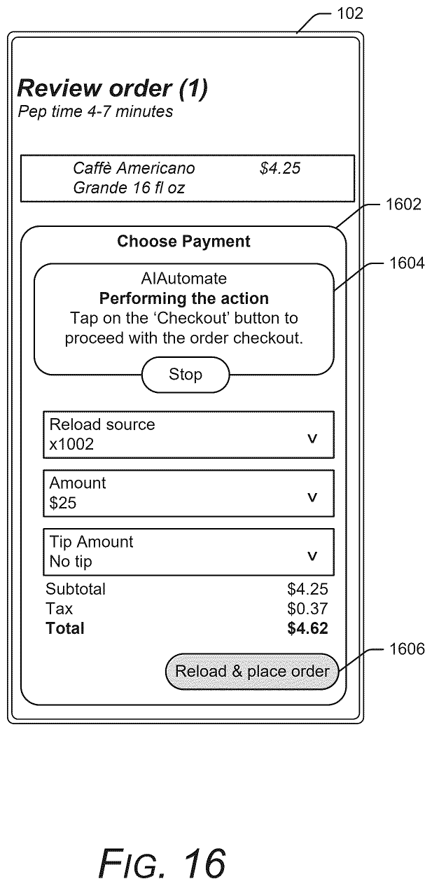

FIG. 16 illustrates the electronic device 102 after the task execution system 116 has taken the action of tapping the “Checkout” button 1508 illustrated in FIG. 15. After tapping on the “Checkout” button 1508, the application UI 1602 is displayed, indicating the method of payment and tip for the order. A notification 1604 is also displayed indicating that the action of tapping the “Checkout” button 1508 was taken.

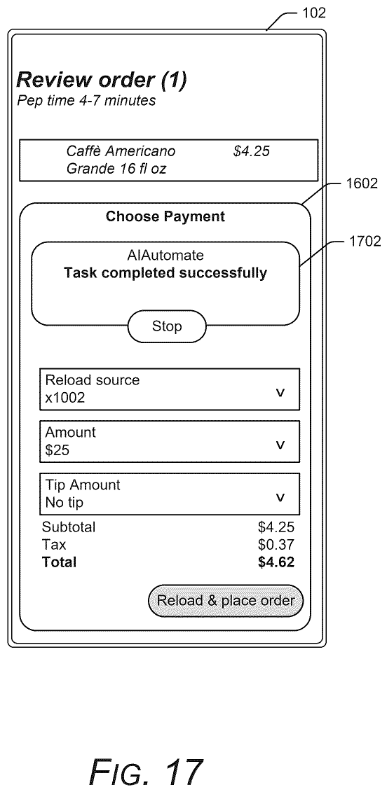

FIG. 17 illustrates the electronic device 102 after the task execution system 116 has taken the action of tapping the “Place order” button 1606 illustrated in FIG. 16. After tapping the “Place order” button 1606, the application UI 1602 is displayed, indicating the method of payment and tip for the order. A notification 1702 is also displayed indicating that the task was successfully completed.

It should be noted that although FIGS. 4-17 illustrate notifications of the task being performed or that has been performed, such notifications are optional. In one or more implementations, the actions are performed without displaying any notification of what task is being performed or has been performed.

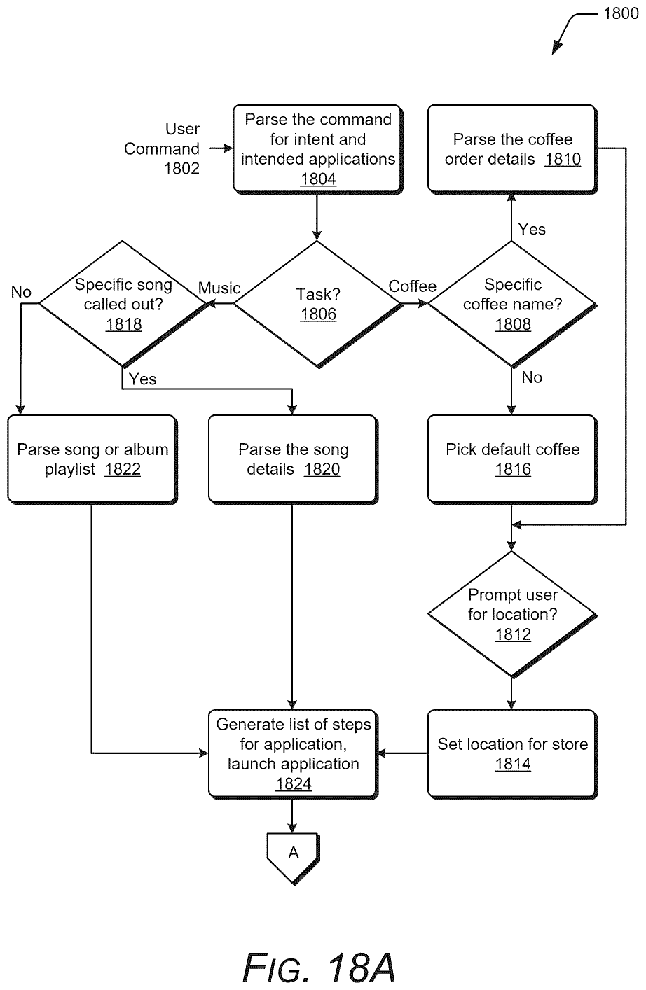

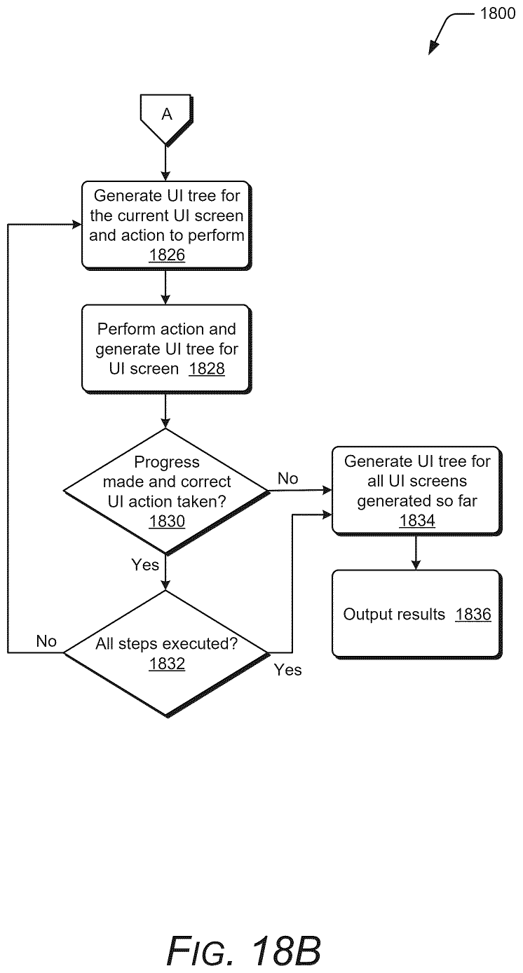

FIGS. 18A and 18B illustrate a flow chart depicting an example method 1800 in accordance with one or more implementations. The method 1800 is implemented by, for example, the task execution system 300 of FIG. 3 and illustrates an example where the task execution system 300 can perform two tasks: order coffee or play music. At 1802, a user inputs a command to perform a task. At 1804, the command is parsed to determine the intent (e.g., order coffee or play music) and intended application to use. The intended application can be determined, for example, by the step generation model 316 and/or the UI action generation model 318 of FIG. 3.

At 1806, the method 1800 proceeds based on whether the task is order coffee or play music. If the task is order coffee, then at 1808 the method 1800 proceeds based on whether a specific coffee name (e.g., store or provider) was specified. At 1810, if a specific coffee name was provided, the coffee order details are parsed, identifying various details regarding the coffee order (e.g., type of coffee, type of milk, etc.), which can be obtained from the personal knowledge base 304 of FIG. 3.

At 1812, the user is prompted about what location he or she prefers, such as a nearby location, the user's favorite location, or a different location. At 1814, the location is set for the store or provider for the coffee based on the user input.

At 1816, if a specific coffee name was not provided, a default (e.g., canned) coffee is selected. This default coffee can be obtained from the personal knowledge base 304.

At 1806, if the task is play music, then at 1818 a determination is made as to whether a specific song was specified by the user. If a specific song was specified by the user, then at 1820 the song details are parsed (e.g., the name of the song is identified). If a specific song was not specified by the user, then at 1822 a song or album playlist of the user are parsed (e.g., a name of a song or album is identified). The song or album playlist of the user is available, for example, from the personal knowledge base 304, or may be generated by the AI system 306 (e.g., the step generation model 316).

At 1824, the list of steps for performing the task (ordering coffee or playing music) is generated and the application is launched. At 1826, the UI tree for the current UI screen is generated and an action to perform based on a next step in the list of steps for performing the task is generated. At 1828, the generated UI action is performed and a UI tree for the UI screen after the action is performed is generated. This UI tree for the UI screen generated at 1828 can be used to verify that progress in performing the task is being made and that the correct UI action was taken. For example, given the UI tree for the application performing the task, the AI system 306 can determine if the UI screen generated at 1828 is the correct UI screen for the task.

At 1830, if the UI tree generated at 1828 shows progress in performing the task is being made and that the correct UI action was taken, then at 1832 a determination is made as to whether all of the steps for performing the task have been executed. If all of the steps for performing the task have not been executed, then the method 1800 returns to 1826 to send the UI tree for the current UI screen (which was generated at 1828) and an action to perform based on a next step in the list of steps for performing the task is generated.

If all of the steps for performing the task have been executed, then at 1834 a UI tree for all UI screens generated so far during the method 1800 is generated and parsed, e.g., to further train models in the AI system 306 of FIG. 3. At 1836, the result of the task is output (e.g., an indication that the task was completed is displayed or output audibly, an indication that the task was not completed is displayed or output audibly, a song is played).

At 1830, if the UI tree generated at 1828 does not show progress in performing the task is being made and/or that the correct UI action was not taken, then the method 1800 stops performing the task and proceeds to 1834, where a UI tree for all UI screens generated so far during the method 1800 is generated and parsed.

Returning to FIG. 3, in one or more implementations the task execution system 300 launches two or more applications to perform the task 310, and for each of the two or more applications determines and performs the actions for the task as discussed above. The launching of the two or more applications can be some of the initial actions in the list of actions 326. At least one of the two or more applications to use to complete the task is determined based at least in part on which of the two or more applications are able to fulfill the task.

In one or more implementations, the step generation model 316 and/or the UI action generation model 318 learn whether an application can fulfill a task. This can be learned in various manners, such as learning that a user cancels a task when certain UI elements have certain values (e.g., quantity of zero, “unavailable”). The list of actions 326 for an application can include an action to cancel the task for the application (e.g., close the application or select a Cancel button) or cease performing actions for the task if the application cannot fulfill the task. In the situation where only one of the two or more applications can fulfill the task, then the UI automatic action agent 320 can complete the task for the application that can fulfill the task, and terminate the task for an application that cannot complete the task. For example, if the task is to order 30 pizzas available at 1 pm and an application or service provider cannot fulfill that request, the task is terminated for that application.

Additionally or alternatively, the UI automatic action agent 320 prompts the user to select at least one of the two or more applications to use to complete the task, and the UI automatic action agent 320 completes the task (e.g., selects a Confirm or Complete button) for the selected application and does not complete the task (e.g., selects a Cancel button or closes the application) for any application that is not selected. This allows the user to have the final say in how best to fulfill the task. For example, the user can select the car from the rideshare application that is not his preferred size but will pick him up sooner and is cheaper, or can select the car from the rideshare application that is his preferred size even though it will pick him up later and/or is more expensive.

The UI actions performed by the UI automatic action agent 320 for the two or more applications can be performed in the foreground, in the background, or a combination thereof. In situations in which the UI actions performed by the UI automatic action agent 320 for the two or more applications are performed in the foreground, the two applications can be displayed simultaneously. For example, if the electronic device has a single display then the display can be split (e.g., vertically or horizontally) into two parts with the UI for each application displayed in a different part. By way of another example, if the electronic device has multiple displays or is coupled with an external display, then the UI for each application can be displayed on a different one of the multiple displays.

In one or more implementations, multiple of the two or more applications can be selected automatically. This can be learned by the step generation model 316 or UI action generation model 318 in various manners, such as learning that the values in certain UI elements (e.g., numeric values indicating quantity) of one application can be combined with values in corresponding UI elements (e.g., numeric values indicating quantity) of another application, and separating out part of the task across those UI elements of those applications. Additionally or alternatively, multiple of the two or more applications can be selected by user input selecting the multiple applications and the values for the UI elements of the multiple applications. In this situation, different parts of the task are performed by different ones of the multiple applications. This allows two applications neither of which can individually fulfill the task but collectively can fulfill the task.

For example, assume a task is to order 50 pizzas for a party. If there are two pizza delivery applications and each indicates that the maximum order is 25 pizzas, then the task can be completed on both of the applications with a quantity UI element indicating 25 pizzas.

As an example of using at least one of two or more applications to complete a task based at least in part on which of the two or more applications are able to fulfill the task, assume a situation where a family of three are traveling including a small baby that needs to have a car seat. When the task is ordering a vehicle for a ride, the task execution system 300 knows from the family's flight itinerary that three people are travelling and one of them is minor that needs a car seat. A first rideshare application may not have any cars available that have a car seat, whereas a second rideshare application does have cars available that have a car seat. In such situations, the second rideshare application is selected because the first rideshare application is not able to fulfill the task.

As another example, assume a user has an office party to host and wants to order donuts in bulk. If the store the user regularly buys from shows out of order, the task execution system 116 can check availability of donuts using multiple different applications in a split screen, allowing an alternative source for the donuts to be readily determined.

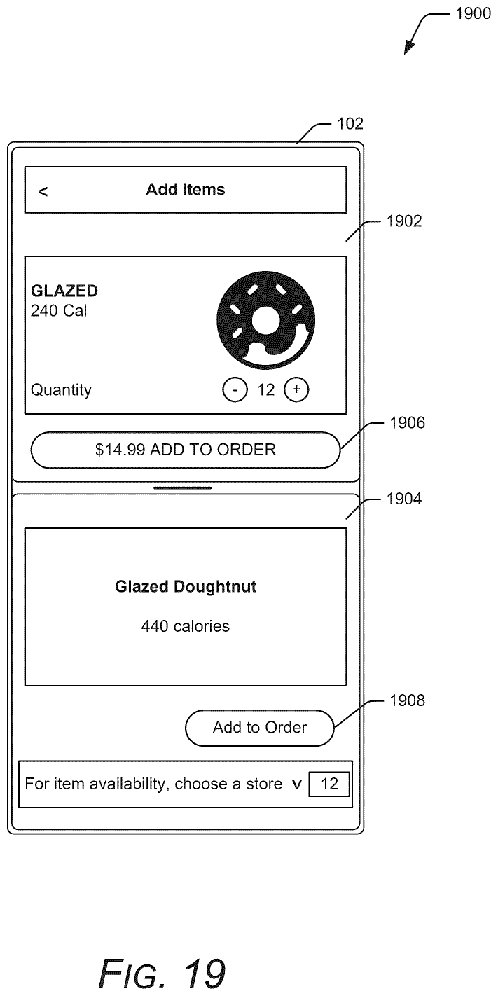

FIG. 19 illustrates an example 1900 of multiple applications in a split screen in accordance with the techniques discussed herein. In the example 1900, the display of the electronic device 102 is split vertically with a UI screen 1902 for a first application displayed above or on top of a UI screen 1904 for a second application. In each of the two applications, when the task execution system 116 reaches the step of adding the donuts to the order, the task execution system 116 prompts the user for input as to which application to use for the order. For example, the user taps button 1906 to order donuts from the store illustrated in UI screen 1902, and taps button 1908 to order donuts from the store illustrated in UI screen 1904.

As another example, assume a user is travelling to a city that he has never visited and has a conference to attend starting at a specific time. Since there are many people who are trying to book at the same time, rides are not available quickly and the user needs to check multiple ride ordering applications for availability options. The task execution system 116 can book a faster available ride based on the user's schedule and checking different rideshare applications at the same time. This simplifies the process of booking a ride, specifically by reducing the work of launching different applications, searching through options to book a ride, finding the drop-off address, and so forth.

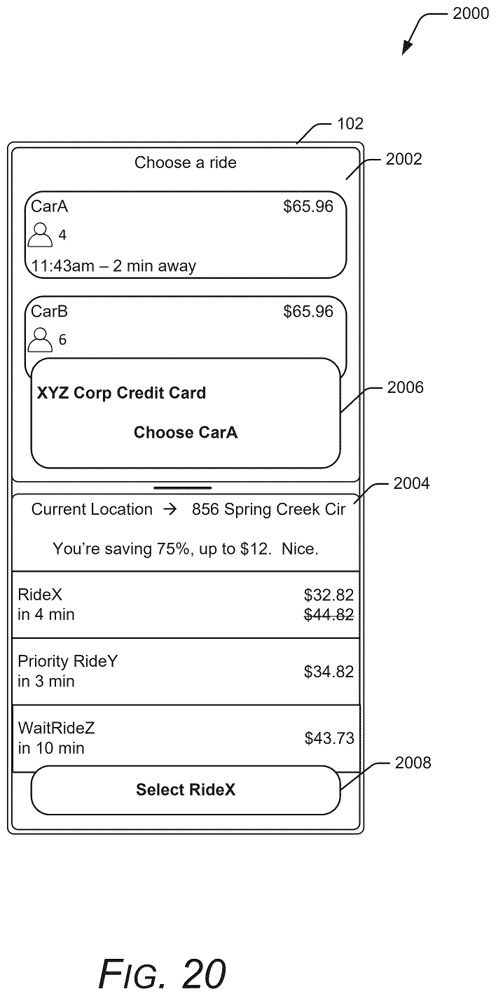

FIG. 20 illustrates an example 2000 of multiple applications in a split screen in accordance with the techniques discussed herein. In the example 2000, the display of the electronic device 102 is split vertically with a UI screen 2002 for a first rideshare application displayed above or on top of a UI screen 2004 for a second rideshare application. In each of the two applications, when the task execution system 116 reaches the step of selecting or choosing to book a ride with the application, the task execution system 116 prompts the user for input as to which application to use for the ride. For example, the user taps button 2006 to book a ride using the first rideshare application, and taps button 2008 to book a ride using the second rideshare application.

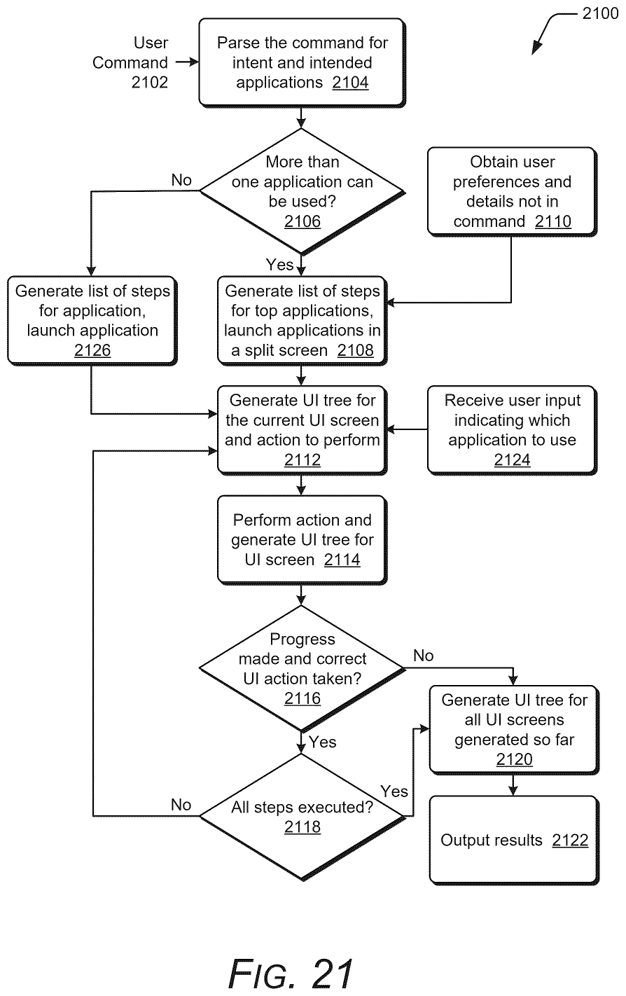

FIG. 21 illustrates a flow chart depicting an example method 2100 in accordance with one or more implementations. The method 2100 is implemented by, for example, the task execution system 300 of FIG. 3. At 2102, a user inputs a command to perform a task. At 2104, the command is parsed to determine the intent (e.g., the task being requested) and one or more applications that can be used to perform the task are identified. The one or more applications can be determined, for example, by the step generation model 316, the UI action generation model 318 of FIG. 3, or a separate AI model.

At 2106, the method 2100 proceeds based on whether more than one application can be used to perform the task. If more than one application can be used to perform the task, then at 2108, the list of steps for performing the task is generated for each of the top n (e.g., 2) applications preferred or used by the user. The top n applications are launched in a split screen on the electronic device, or displayed on two different screens if the electronic device is coupled with an additional display device. User preferences and details not indicated in the command can be obtained from the personal knowledge base 304 at 2110.

At 2112, for each of the top n applications, the UI tree for the current UI screen is generated and an action to perform based on a next step in the list of steps for performing the task is generated. At 2114, the generated UI action is performed and a UI tree for the UI screen after the action is performed is generated. This UI tree for the UI screen generated at 2114 can be used to verify that progress in performing the task is being made and that the correct UI action was taken. For example, given the UI tree for the application performing the task, the AI system 306 can determine if the UI screen generated at 2114 is the correct UI screen for the task.

At 2116, if the UI tree generated at 2114 shows progress in performing the task is being made and that the correct UI action was taken, then at 2118 a determination is made as to whether all of the steps for performing the task have been executed. If all of the steps for performing the task have not been executed, then the method 2100 returns to 2112 to send the UI tree for the current UI screen (which was generated at 2114) and an action to perform based on a next step in the list of steps for performing the task is generated.

If all of the steps for performing the task have been executed, then at 2120 a UI tree for all UI screens generated so far during the method 2100 for each of the top n applications is generated and parsed, e.g., to further train models in the AI system 306 of FIG. 3. At 2122, the results of the options available that fulfill the command and user preferences are output (e.g., results are displayed or output audibly). At 2124, the user is queried and user input is received selecting one of the top n applications to proceed with completing the final steps of the task.

At 2116, if the UI tree generated at 2114 does not show progress in performing the task is being made and/or that the correct UI action was not taken for at least one of the top n applications, then the method 2100 stops performing the task and proceeds to 2120, where a UI tree for all UI screens generated so far during the method 2100 is generated and parsed.

At 2126, if more than one application cannot be used to perform the task, then the list of steps for performing the task is generated for each of the one application that can perform the task and the one application is launched.

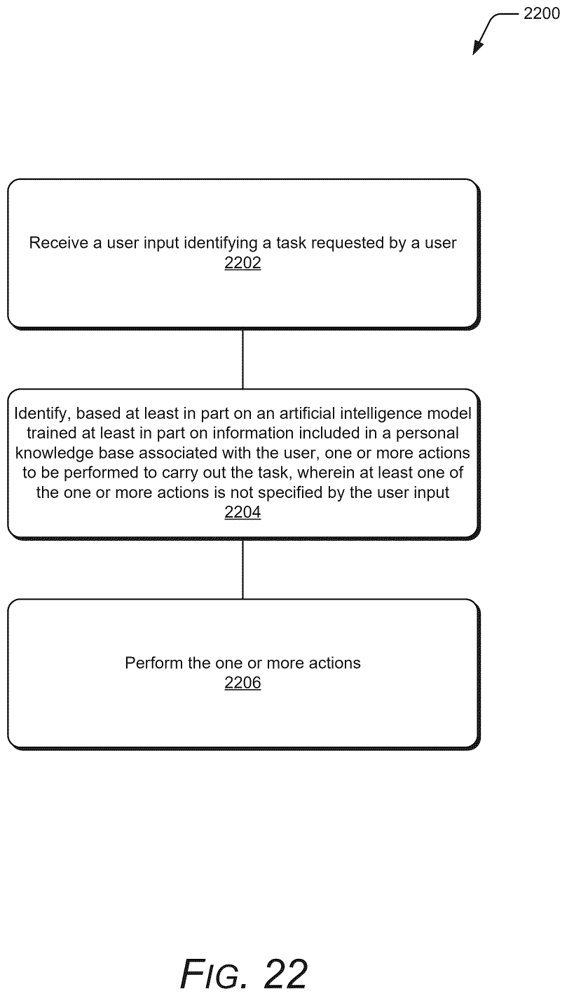

FIG. 22 illustrates an example process 2200 for implementing the techniques discussed herein in accordance with one or more embodiments. Process 2200 is carried out by a task execution system, such as task execution system 116 of FIG. 1 or FIG. 2, or task execution system 300 of FIG. 3, and can be implemented in software, firmware, hardware, or combinations thereof. Process 2200 is shown as a set of acts and is not limited to the order shown for performing the operations of the various acts.

In process 2200, a user input identifying a task requested by a user is received (act 2202). The user input can be, for example, a voice input or a text input.

One or more actions to be performed to carry out the task are identified (act 2204). The one or more actions are indicated in terms of interacting with one or more UI elements (e.g., clicking this UI element, inputting text in this other UI element, scroll this view, and so forth). The one or more actions are automatically identified by the task execution system based at least in part on an artificial intelligence model trained at least in part on information included in a personal knowledge base associated with the user. At least one of the one or more actions is not specified by the user input.

The one or more actions are performed (act 2206).

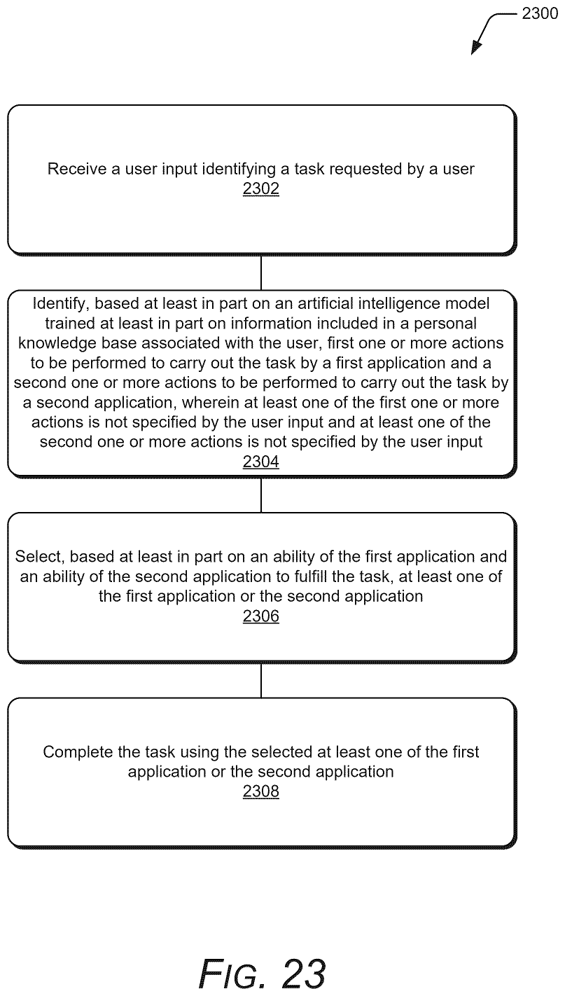

FIG. 23 illustrates an example process 2300 for implementing the techniques discussed herein in accordance with one or more embodiments. Process 2300 is carried out by a task execution system, such as task execution system 116 of FIG. 1 or FIG. 2, or task execution system 300 of FIG. 3, and can be implemented in software, firmware, hardware, or combinations thereof. Process 2300 is shown as a set of acts and is not limited to the order shown for performing the operations of the various acts.

In process 2300, a user input identifying a task requested by a user is received (act 2302). The user input can be, for example, a voice input or a text input.

First one or more actions to be performed to carry out the task by a first application and a second one or more actions to be performed to carry out the task by a second application identify are identified (act 2304). The first one or more actions and second one or more actions are indicated in terms of interacting with one or more UI elements (e.g., clicking this UI element, inputting text in this other UI element, scroll this view, and so forth). The first one or more actions and the second one or more actions are automatically identified based at least in part on an artificial intelligence model trained at least in part on information included in a personal knowledge base associated with the user. At least one of the first one or more actions is not specified by the user input and at least one of the second one or more actions is not specified by the user input.

At least one of the first application or the second application is selected (act 2306). The selection is based at least in part on an ability of the first application and an ability of the second application to fulfill the task.

The task is completed using the selected at least one of the first application or the second application (act 2308).

FIG. 24 illustrates various components of an example electronic device that can implement embodiments of the techniques discussed herein. The electronic device 2400 can be implemented as any of the devices described with reference to the previous Figs., such as any type of client device, mobile phone, tablet, computing, communication, entertainment, gaming, media playback, or other type of electronic device. In one or more embodiments the electronic device 2400 includes the task execution system 116, described above.

The electronic device 2400 includes one or more data input components 2402 via which any type of data, media content, or inputs can be received such as user-selectable inputs, messages, music, television content, recorded video content, and any other type of text, audio, video, or image data received from any content or data source. The data input components 2402 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 2402 may also include various other input components such as microphones, touch sensors, touchscreens, keyboards, and so forth.

The device 2400 includes communication transceivers 2404 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The device 2400 includes a processing system 2406 of one or more processors (e.g., any of microprocessors, controllers, and the like) or a processor and memory system implemented as a system-on-chip (SoC) that processes computer-executable instructions. The processing system 2406 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 2408. The device 2400 may further include any type of a system bus or other data and command transfer system that couples the various components within the device. A system bus can include any one or combination of different bus structures and architectures, as well as control and data lines.

The device 2400 also includes computer-readable storage memory devices 2410 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 2410 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 2400 may also include a mass storage media device.

The computer-readable storage memory device 2410 provides data storage mechanisms to store the device data 2412, other types of information or data, and various device applications 2414 (e.g., software applications). For example, an operating system 2416 can be maintained as software instructions with a memory device and executed by the processing system 2406 to cause the processing system 2406 to perform various acts. The device applications 2414 may also include a device manager, such as any form of a control application, software application, signal-processing and control module, code that is native to a particular device, a hardware abstraction layer for a particular device, and so on.

Although the task execution system 116 is illustrated as being maintained in the computer-readable storage memory device 2410, it is to be appreciated that the task execution system 116 can be implemented separate from the computer-readable storage memory device 2410, such as in hardware (e.g., as an ASIC, an FPGA, an ASSP, an SoC, a CPLD, and the like).

The device 2400 can also include one or more device sensors 2418, such as any one or more of an ambient light sensor, a proximity sensor, a touch sensor, an infrared (IR) sensor, accelerometer, gyroscope, thermal sensor, audio sensor (e.g., microphone), and the like. The device 2400 can also include one or more power sources 2420, such as when the device 2400 is implemented as a mobile device. The power sources 2420 may include a charging or power system, and can be implemented as a flexible strip battery, a rechargeable battery, a charged super-capacitor, or any other type of active or passive power source.

The device 2400 additionally includes an audio or video processing system 2422 that generates one or both of audio data for an audio system 2424 and display data for a display system 2426. In accordance with some embodiments, the audio/video processing system 2422 is configured to receive call audio data from the transceiver 2404 and communicate the call audio data to the audio system 2424 for playback at the device 2400. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

In the discussions herein, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set”may include one or more elements.

Although various of techniques have been described herein in language specific to features or methods, the subject of the appended claims is not necessarily limited to the specific features or methods described. Rather, the specific features and methods are disclosed as example implementations of techniques for implementing artificial intelligence based task execution on an electronic device. Further, various different implementations are described, and it is to be appreciated that each described implementation can be implemented independently or in connection with one or more other described implementations. Additional aspects of the techniques, features, and/or methods discussed herein relate to one or more of the following.

In one or more implementations, artificial intelligence based application selection for task execution based on fulfillment capacity is discussed herein. An electronic device receives a user input identifying a task requested by a user. Based on an artificial intelligence model trained on information included in a personal knowledge base associated with the user, first one or more actions to be performed to carry out the task by a first application and second one or more actions to be performed to carry out the task by a second application are identified, where at least one of the first one or more actions and at least one of the second one or more actions is not specified by the user input. At least one of the first application or the second application is selected based at least in part on an ability of the first application and the second application to fulfill the task. The task is completed using the selected at least one of the first application or the second application.

In some aspects, the techniques described herein relate to a first electronic device including: at least one memory; and at least one processor coupled with the at least one memory and configured to cause the electronic device to: receive a user input identifying a task requested by a user; identify, based at least in part on an artificial intelligence model trained at least in part on information included in a personal knowledge base associated with the user, one or more actions to be performed to carry out the task, wherein at least one of the one or more actions is not specified by the user input; perform the one or more actions.

In some aspects, the techniques described herein relate to a first electronic device, wherein the user input includes a text input or a speech input.

In some aspects, the techniques described herein relate to a first electronic device, wherein at least one processor is configured to cause the electronic device to receive the user input from a second electronic device separate from the first electronic device.

In some aspects, the techniques described herein relate to a first electronic device, wherein an application to perform the task is automatically identified by the artificial intelligence model.

In some aspects, the techniques described herein relate to a first electronic device, wherein the one or more actions include one or more interactions with one or more user interface elements of the application.

In some aspects, the techniques described herein relate to a first electronic device, wherein the at least one processor is configured to cause the first electronic device to perform the one or more actions in a background that is not visible to the user.

In some aspects, the techniques described herein relate to a first electronic device, wherein the artificial intelligence model is trained at least in part on a tree of actionable user interface elements on the first electronic device.

In some aspects, the techniques described herein relate to a first electronic device, wherein the personal knowledge base stores information regarding the user that relates to at least one of the one or more actions.

In some aspects, the techniques described herein relate to a method performed by a first electronic device, the method including: receiving a user input identifying a task requested by a user; identifying, based at least in part on an artificial intelligence model trained at least in part on information included in a personal knowledge base associated with the user, one or more actions to be performed to carry out the task, wherein at least one of the one or more actions is not specified by the user input; and performing the one or more actions.

In some aspects, the techniques described herein relate to a method, wherein the user input includes a text input or a speech input.

In some aspects, the techniques described herein relate to a method, wherein the receiving includes receiving the user input from a second electronic device separate from the first electronic device.

In some aspects, the techniques described herein relate to a method, wherein an application to perform the task is automatically identified by the artificial intelligence model.

In some aspects, the techniques described herein relate to a method, wherein the one or more actions include one or more interactions with one or more user interface elements of the application.

In some aspects, the techniques described herein relate to a method, wherein the performing includes performing the one or more actions in a background that is not visible to the user.

In some aspects, the techniques described herein relate to a method, wherein the artificial intelligence model is trained at least in part on a tree of actionable user interface elements on the first electronic device.

In some aspects, the techniques described herein relate to a method, wherein the personal knowledge base stores information regarding the user that relates to at least one of the one or more actions.

In some aspects, the techniques described herein relate to a system including: a display device; and a task execution system to: receive a user input identifying a task requested by a user; identify, based at least in part on an artificial intelligence model trained at least in part on information included in a personal knowledge base associated with the user, one or more actions to be performed to carry out the task, wherein at least one of the one or more actions is not specified by the user input; perform the one or more actions.

In some aspects, the techniques described herein relate to a system, wherein the task execution system is to receive the user input from an electronic device separate from the system.

In some aspects, the techniques described herein relate to a system, wherein an application to perform the task is automatically identified by the artificial intelligence model.

In some aspects, the techniques described herein relate to a system, wherein the one or more actions include one or more interactions with one or more user interface elements of the application.

In some aspects, the techniques described herein relate to a first electronic device including: at least one memory; and at least one processor coupled with the at least one memory and configured to cause the electronic device to: receive a user input identifying a task requested by a user; identify, based at least in part on an artificial intelligence model trained at least in part on information included in a personal knowledge base associated with the user, first one or more actions to be performed to carry out the task by a first application and a second one or more actions to be performed to carry out the task by a second application, wherein at least one of the first one or more actions is not specified by the user input and at least one of the second one or more actions is not specified by the user input; select, based at least in part on an ability of the first application and an ability of the second application to fulfill the task, at least one of the first application or the second application; complete the task using the selected at least one of the first application or the second application.

In some aspects, the techniques described herein relate to a first electronic device, wherein to select at least one of the first application or the second application, the at least one processor is configured to cause the first electronic device to automatically select at least one of the first application or the second application.

In some aspects, the techniques described herein relate to a first electronic device, wherein in response to only one of the first application and the second application being able to fulfill the task, to automatically select at least one of the first application or the second application the at least one processor is further configured to cause the first electronic device to automatically select the one of the first application and the second application that can fulfill the task.

In some aspects, the techniques described herein relate to a first electronic device, wherein the at least one processor is further configured to cause the first electronic device to: concurrently display a first confirmation user interface for the first application and a second confirmation user interface for the second application; select the at least one of the first application or the second application based on a user input selecting a first user interface element on the first confirmation user interface or a second user interface element on the second confirmation user interface.

In some aspects, the techniques described herein relate to a first electronic device, wherein the at least one processor is further configured to cause the first electronic device to: display a first user interface indicating an ability for the first application to fulfill the task; display a second user interface indicating an ability for the second application to fulfill the task; receive user input selecting both the first application and the second application; and complete the task using both the first application and the second application.

In some aspects, the techniques described herein relate to a first electronic device, wherein in response to the first application and the second application being unable to fulfill the task individually but being able to fulfill the task together, to automatically select at least one of the first application or the second application the at least one processor is further configured to cause the first electronic device to automatically select both the first application and the second application to complete the task.

In some aspects, the techniques described herein relate to a first electronic device, wherein the at least one processor is further configured to automatically identify the first application and the second application using the artificial intelligence model.

In some aspects, the techniques described herein relate to a method performed by a first electronic device, the method including: receiving a user input identifying a task requested by a user; identifying, based at least in part on an artificial intelligence model trained at least in part on information included in a personal knowledge base associated with the user, first one or more actions to be performed to carry out the task by a first application and a second one or more actions to be performed to carry out the task by a second application, wherein at least one of the first one or more actions is not specified by the user input and at least one of the second one or more actions is not specified by the user input; selecting, based at least in part on an ability of the first application and an ability of the second application to fulfill the task, at least one of the first application or the second application; and completing the task using the selected at least one of the first application or the second application.

In some aspects, the techniques described herein relate to a method, wherein selecting at least one of the first application or the second application includes automatically selecting at least one of the first application or the second application.

In some aspects, the techniques described herein relate to a method, wherein in response to only one of the first application and the second application being able to fulfill the task, automatically selecting at least one of the first application or the second application includes automatically selecting the one of the first application and the second application that can fulfill the task.

In some aspects, the techniques described herein relate to a method, further including: concurrently displaying a first confirmation user interface for the first application and a second confirmation user interface for the second application; and selecting the at least one of the first application or the second application based on a user input selecting a first user interface element on the first confirmation user interface or a second user interface element on the second confirmation user interface.

In some aspects, the techniques described herein relate to a method, further including: displaying a first user interface indicating an ability for the first application to fulfill the task; displaying a second user interface indicating an ability for the second application to fulfill the task; receiving user input selecting both the first application and the second application; and completing the task using both the first application and the second application.

In some aspects, the techniques described herein relate to a method, wherein in response to the first application and the second application being unable to fulfill the task individually but being able to fulfill the task together, the selecting at least one of the first application or the second application includes automatically selecting both the first application and the second application to complete the task.

In some aspects, the techniques described herein relate to a method, further including automatically identifying the first application and the second application using the artificial intelligence model.

In some aspects, the techniques described herein relate to a system including: a display device; and a task execution system to: receive a user input identifying a task requested by a user; identify, based at least in part on an artificial intelligence model trained at least in part on information included in a personal knowledge base associated with the user, first one or more actions to be performed to carry out the task by a first application and a second one or more actions to be performed to carry out the task by a second application, wherein at least one of the first one or more actions is not specified by the user input and at least one of the second one or more actions is not specified by the user input; select, based at least in part on an ability of the first application and an ability of the second application to fulfill the task, at least one of the first application or the second application; complete the task using the selected at least one of the first application or the second application.

In some aspects, the techniques described herein relate to a system, wherein to select at least one of the first application or the second application, the task execution system is to automatically select at least one of the first application or the second application.

In some aspects, the techniques described herein relate to a system, wherein in response to only one of the first application and the second application being able to fulfill the task, the task execution system is to automatically select the one of the first application and the second application that can fulfill the task.

In some aspects, the techniques described herein relate to a system, wherein the task execution system is to: concurrently display a first confirmation user interface for the first application and a second confirmation user interface for the second application; select the at least one of the first application or the second application based on a user input selecting a first user interface element on the first confirmation user interface or a second user interface element on the second confirmation user interface.

In some aspects, the techniques described herein relate to a system, wherein the task execution system is to: display a first user interface indicating an ability for the first application to fulfill the task; display a second user interface indicating an ability for the second application to fulfill the task; receive user input selecting both the first application and the second application; and complete the task using both the first application and the second application.

In some aspects, the techniques described herein relate to a system, wherein in response to the first application and the second application being unable to fulfill the task individually but being able to fulfill the task together, the task execution system is to automatically select both the first application and the second application to complete the task.

What is claimed is:

1. A first electronic device comprising:
at least one memory; and
at least one processor coupled with the at least one memory and configured to cause the electronic device to:
receive a user input identifying a task requested by a user;
identify, based at least in part on an artificial intelligence model trained at least in part on information included in a personal knowledge base associated with the user, one or more actions to be performed to carry out the task, wherein at least one of the one or more actions is not specified by the user input;
perform the one or more actions.

2. The first electronic device of claim 1, wherein the user input comprises a text input or a speech input.

3. The first electronic device of claim 1, wherein at least one processor is configured to cause the electronic device to receive the user input from a second electronic device separate from the first electronic device.

4. The first electronic device of claim 1, wherein an application to perform the task is automatically identified by the artificial intelligence model.

5. The first electronic device of claim 4, wherein the one or more actions comprise one or more interactions with one or more user interface elements of the application.

6. The first electronic device of claim 1, wherein the at least one processor is configured to cause the first electronic device to perform the one or more actions in a background that is not visible to the user.

7. The first electronic device of claim 1, wherein the artificial intelligence model is trained at least in part on a tree of actionable user interface elements on the first electronic device.

8. The first electronic device of claim 1, wherein the personal knowledge base stores information regarding the user that relates to at least one of the one or more actions.

9. A method performed by a first electronic device, the method comprising:
receiving a user input identifying a task requested by a user;
identifying, based at least in part on an artificial intelligence model trained at least in part on information included in a personal knowledge base associated with the user, one or more actions to be performed to carry out the task, wherein at least one of the one or more actions is not specified by the user input; and
performing the one or more actions.

10. The method of claim 9, wherein the user input comprises a text input or a speech input.

11. The method of claim 9, wherein the receiving comprises receiving the user input from a second electronic device separate from the first electronic device.

12. The method of claim 9, wherein an application to perform the task is automatically identified by the artificial intelligence model.

13. The method of claim 12, wherein the one or more actions comprise one or more interactions with one or more user interface elements of the application.

14. The method of claim 9, wherein the performing comprises performing the one or more actions in a background that is not visible to the user.

15. The method of claim 9, wherein the artificial intelligence model is trained at least in part on a tree of actionable user interface elements on the first electronic device.

16. The method of claim 9, wherein the personal knowledge base stores information regarding the user that relates to at least one of the one or more actions.

17. A system comprising:
a display device; and
a task execution system to:
receive a user input identifying a task requested by a user;
identify, based at least in part on an artificial intelligence model trained at least in part on information included in a personal knowledge base associated with the user, one or more actions to be performed to carry out the task, wherein at least one of the one or more actions is not specified by the user input;
perform the one or more actions.

18. The system of claim 17, wherein the task execution system is to receive the user input from an electronic device separate from the system.

19. The system of claim 17, wherein an application to perform the task is automatically identified by the artificial intelligence model.

20. The system of claim 19, wherein the one or more actions comprise one or more interactions with one or more user interface elements of the application.
